(19) United States
(12) Patent Application Publication
(10) Pub. No.: US 2021/0325989 A1
(43) Pub. Date: Oct. 21, 2021

(54) TOUCH SENSOR COMPONENT AND ELECTRONIC DEVICE THEREOF

(71) Applicant: WUHAN CHINA STAR OPTOELECTRONICS TECHNOLOGY CO., LTD., Wuhan (CN)

(72) Inventors: Yuejun Tang, Wuhan (CN); Xueyun Li, Wuhan (CN)

(73) Assignee: WUHAN CHINA STAR OPTOELECTRONICS TECHNOLOGY CO., LTD., Wuhan (CN)

(21) Appl. No.: 16/462,006

(22) PCT Filed: Feb. 19, 2019
(86) PCT No.: PCT/CN2019/075422

§ 371 Date: May 17, 2019

(30) Foreign Application Priority Data
Oct. 31, 2018 (CN) 201811282834.0

(51) Int. Cl. G06F 3/041

(52) U.S. Cl. CPC G06F 3/0412

(57) ABSTRACT

A sensor component and an electronic device thereof are provided and comprise a substrate having a first region, a bend region, a second region, and a binding region. A sensor touch layer is disposed on the substrate. The sensor touch layer comprises a first touch sensor block, a second touch sensor block, and a binding block. The first touch sensor block is disposed on the first region, the second touch sensor block is disposed on the second region, and the binding block is disposed on the binding region. The binding block is electrically connected to the first touch sensor block and the second sensor block.

### BACKGROUND OF INVENTION

### Field of Invention

The present invention relates to a display field and particularly to a touch sensor component and an electronic device.

### Description of Prior Art

Currently, organic light emitting diode displays used as display devices for displaying an image has been of interest. Unlike liquid crystal display devices, organic light emitting diode displays have self-emitting properties and do not have a backlight source, so they can be fabricated thinner and lighter than the display devices with a backlight source. Therefore, it is relatively easy to achieve double-sided displays. However, both sides of double-sided organic light emitting diode displays having a touch function are still under research, and most of them are separately provided with a touch sensor layer on both sides, and fabrication processes are complicated and have a high cost. Therefore, prior art has drawbacks and is in urgent need of improvement.

### SUMMARY OF INVENTION

The present invention's main purpose is to provide a touch sensor component and an electronic device and has beneficial effects like minimizing processing steps and lowering the cost.

According to one embodiment of the present invention, a touch sensor component comprises:

a substrate, wherein the substrate comprises a first region, a bend region, a second region and a binding region;

a touch sensor layer, wherein the touch sensor layer is disposed on the substrate, the touch sensor layer comprises a first touch sensor block, a second touch sensor block and a binding block, the first touch sensor block is disposed on the first region, the second touch sensor block is disposed on the second region, the binding block is disposed on the binding region, the binding block is electrically connected to the first touch sensor block and the second touch sensor block, and the binding block is configured to transmit an inductive signal of the first touch sensor block and the second touch sensor block to a touch control chip; and wherein the first region, the bend region, and the second region are sequentially disposed side by side along a first direction, the touch senor layer further comprises a third touch sensor block, and the third touch sensor block is disposed on the bend region.

In one embodiment of the present invention, the binding region is disposed adjacent to the first region and is sequentially disposed along a second direction.

In one embodiment of the present invention, the binding region is disposed adjacent to the second region and is sequentially disposed along a second direction.

In one embodiment of the present invention, the first direction and the second direction are perpendicular to each other.

In one embodiment of the present invention, the first direction and the second direction are perpendicular to each other.

In one embodiment of the present invention, the binding region is disposed adjacent to the first region and the second region.

In one embodiment of the present invention, the binding region comprises a first sub-binding region and a second sub-binding region, the first sub-binding region is disposed adjacent to the first region, and the second sub-binding region is disposed adjacent to the second region; and the binding block comprises a first sub-binding block and a second sub-binding block, the first sub-binding block is disposed on the first sub-binding region, and the second sub-binding block is disposed on the second sub-binding region.

According to one embodiment of the present invention, a touch sensor component comprises:

a substrate, wherein the substrate comprises a first region, a bend region, a second region and a binding region;

a touch sensor layer, wherein the touch sensor layer is disposed on the substrate, the touch sensor layer comprises a first touch sensor block, a second touch sensor block and a binding block, the first touch sensor block is disposed on the first region, the second touch sensor block is disposed on the second region, the binding block is disposed on the binding region, the binding block is electrically connected to the first touch sensor block and the second touch sensor block, and the binding block is configured to transmit an inductive signal of the first touch sensor block and the second touch sensor block to a touch control chip; and

wherein the first region, the bend region, and the second region are sequentially disposed side by side along a first direction, the touch senor layer further comprises a third touch sensor block, and the third touch sensor block is disposed on the bend region.

In one embodiment of the present invention, the first region, the bend region, and the second region are sequentially disposed side by side along a first direction.

In one embodiment of the present invention, the binding region is disposed adjacent to the first region and is sequentially disposed along a second direction.

In one embodiment of the present invention, the binding region is disposed adjacent to the second region and is sequentially disposed along a second direction.

In one embodiment of the present invention, the first direction and the second direction are perpendicular to each other.

In one embodiment of the present invention, the first direction and the second direction are perpendicular to each other.

In one embodiment of the present invention, the binding region is disposed adjacent to the first region and the second region.

In one embodiment of the present invention, the binding region comprises a first sub-binding region and a second sub-binding region, the first sub-binding region is disposed adjacent to the first region, and the second sub-binding region is disposed adjacent to the second region, and the binding block comprises a first sub-binding block and a second sub-binding block, the first sub-binding block is disposed on the first sub-binding region, and the second sub-binding block is disposed on the second sub-binding region.

In one embodiment of the present invention, the touch senor layer further comprises a third touch sensor block, and the third touch sensor block is disposed on the bend region.

According to one embodiment of the present invention, an electronic device comprises a display body and a touch sensor component, and a substrate of the touch sensor component covers the display body;

wherein a touch sensor layer of the touch sensor component is disposed on a side of the substrate away from the display body; or the touch sensor layer of the touch sensing component is disposed on a side of the substrate close to the display body; and the touch sensor component comprises:

a substrate, wherein the substrate comprises a first region, a bend region, a second region and a binding region;

a touch sensor layer, wherein the touch sensor layer is disposed on the substrate, the touch sensor layer comprises a first touch sensor block, a second touch sensor block and a binding block, the first touch sensor block is disposed on the first region, the second touch sensor block is disposed on the second region, the binding block is disposed on the binding region, the binding block is electrically connected to the first touch sensor block and the second touch sensor block, and the binding block is configured to transmit an inductive signal of the first touch sensor block and the second touch sensor block to a touch control chip.

In one embodiment of the present invention, the first region, the bend region, and the second region are sequentially disposed side by side along a first direction.

In one embodiment of the present invention, the binding region is disposed adjacent to the first region and is sequentially disposed along a second direction.

In one embodiment of the present invention, the binding region is disposed adjacent to the second region and is sequentially disposed along a second direction.

A touch sensor component and an electronic device of are provided by the present invention, and a touch sensor layer is fabricated through a foldable transparent flexible substrate, and then the touch sensor layer can be bent to cover both surfaces of the electronic device to form a double-sided touch function layer. The present invention has beneficial effects like minimizing processing steps and lowering the cost.

### BRIEF DESCRIPTION OF DRAWINGS

In order to more clearly illustrate embodiments or technical solutions in the present invention, the drawings used in the description of the embodiments or current technology will be briefly described below. Obviously, the drawings in the following description are merely some embodiments of the present invention. A person skilled in the art may also obtain other drawings without any creative efforts.

FIG. 1 is a first schematic view of a touch sensor component according to one embodiment of the present invention.

FIG. 2 is a second schematic view of a touch sensor component according to one embodiment of the present invention.

FIG. 3 is a third schematic view of a touch sensor component according to one embodiment of the present invention.

FIG. 4 is a fourth schematic view of a touch sensor component according to one embodiment of the present invention.

FIG. 5 is a fifth schematic view of a touch component according to one embodiment of the present invention.

FIG. 6 is a sixth schematic view of a touch component according to one embodiment of the present invention.

FIG. 7 is a first schematic view of an electronic device according to one embodiment of the present invention.

FIG. 8 is a second schematic view of an electronic device according to one embodiment of the present invention.

FIG. 9 is a third schematic view of an electronic device according to one embodiment of the present invention.

FIG. 10 is a fourth schematic view of an electronic device according to one embodiment of the present invention.

### DETAILED DESCRIPTION OF PREFERRED EMBODIMENTS

The embodiments of the present invention are described in detail below, and the examples of the embodiments are illustrated in the drawings, in which the same or similar reference numerals indicate the same or similar elements or elements having the same or similar functions. The embodiments described below with reference to the drawings are used to understand the present invention, but are not to be as limiting.

In the description of the present invention, it is to be understood that the terms “center,” “longitudinal,” “lateral,” “length,” “width,” “thickness,” “upper,” “lower,” “front,” “back,” “left,” “right,” “vertical,” “horizontal,” “top,” “bottom,” “inside,” “outside,” “clockwise,” “counterclockwise,” etc., indicated as orientation or positional relationship are based on the orientation or positional relationship shown in the drawings, they merely intend to illustrate the present invention and simplify the description, but are not to be as indicating or implying specific devices or elements having specific orientation, specific orientation structure and operating. Therefore, it cannot be understood as limitations. Moreover, the terms “first” and “second” are merely used for describing purposes, but are not to be conceived as indicating or implying a relative important or implicitly indicating specific technical feature numbers. Accordingly, the feature limitations of “first” or “second” may include one or more of the described features explicitly or implicitly. In the description of the present invention, the meaning of “a plurality of” is two or more, unless otherwise explicitly defined.

The following disclosure provides many different embodiments or examples for implementing different structures of the present invention. In order to simplify the disclosure of the present invention, the components and arrangements of the specific examples are described below. Of course, they are merely examples and are not intended to limit the invention. In addition, the present invention may be repeated with reference numerals in the various examples, which are for the purpose of simplicity and clarity, and do not indicate the relationship between the various embodiments and/or arrangements discussed. Moreover, the present invention provides embodiments of various specific processes and materials, but a person skilled in the art may recognize the use of other processes and/or the use of other materials.

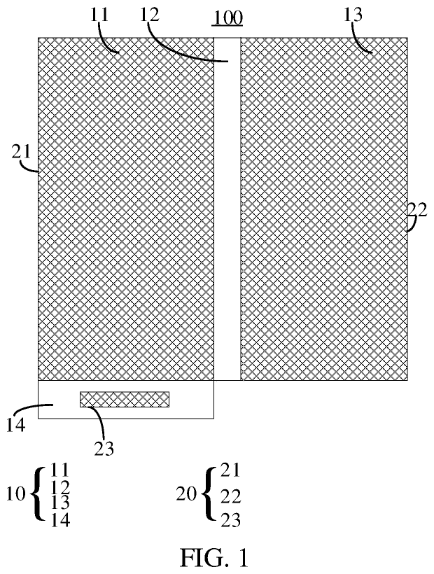

Referring to FIG. 1, it is a schematic view of a touch sensor component according to one embodiment of the present invention. As shown in FIG. 1, a touch sensor component 100 comprises a substrate 10 and a touch sensor layer 20. The touch sensor layer 20 is disposed on the substrate 10.

The substrate 10 is made of a transparent flexible material. For example, the substrate 10 can be polymerized by using one or more of the following materials: polyimide, polycarbonate, polyethersulfone, polyethylene terephthalate, polyethylene naphthalate, polyarylate, and glass fiber reinforced plastic. The use of the touch sensor layer 20 is made of an indium tin oxide (ITO) material but not limited.

In one embodiment, a substrate 10 comprises a first region 11, a bend region 12, a second region 13, and a binding region 14. The first region 11, the bend region 12, and the second region 13 are sequentially disposed side by side along a first direction. The binding region 14 is disposed adjacent to the first region. It should be noted that the first direction is a horizontal direction.

The touch sensor layer 20 comprises a first touch sensor block 21, a second touch sensor block 22, and a binding block 23. The first touch sensor block 21 is disposed on the first region 11, the second touch sensor block 22 is disposed on the second region 13, the binding block 23 is disposed on the binding region 14.

In other words, in one embodiment, the binding block 23 is electrically connected to the first touch sensor block 21 and the second touch sensor block 22, and the binding block 23 is configured to transmit an inductive signal of the first touch sensor block 21 and the second touch sensor block 22 to a touch control chip.

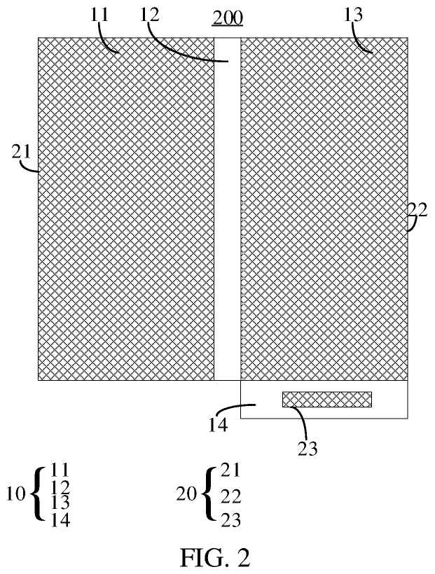

Referring to FIG. 2, it is a second schematic view of a touch sensor component according to one embodiment of the present invention. The difference between the touch sensor component 200 shown in FIG. 2 and the touch sensor component 100 shown in FIG. 1 is that the binding region 14 of the touch sensing component 200 shown in FIG. 2 is disposed adjacent to the second region 13.

As shown in FIG. 2, the substrate 10 comprises a first region 11, a bend region 12, a second region 13, and a binding region 14. The first region 11, the bend region 12, and the second region 13 are sequentially disposed side by side along a first direction. The binding region 14 is disposed adjacent to the second region 13. It should be noted that the first direction is a horizontal direction. The touch sensor layer 20 comprises a first touch sensor block 21, a second touch sensor block 22, and a binding block 23. The first touch sensor block 21 is disposed on the first region 11, the second touch sensor block 22 is disposed on the second region 13, and the binding block 23 is disposed on the binding region 14.

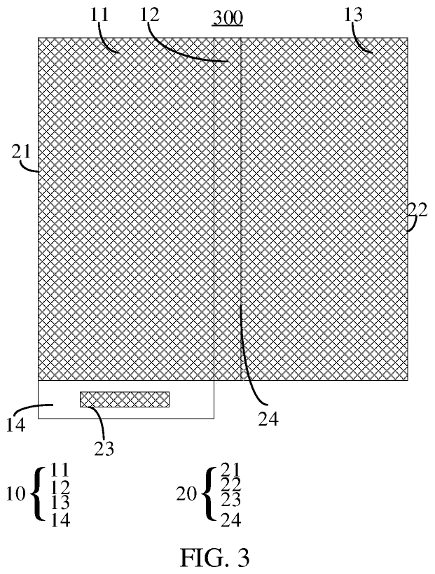

Referring to FIG. 3, it is a third schematic view of a touch sensor component according to one embodiment of the present invention. The difference between the touch sensor component 300 shown in FIG. 3 and the touch sensor component 100 shown in FIG. 1 is that the touch sensor layer 20 of the touch sensor component 300 shown in FIG. 3 further comprises a third touch sensor block 24.

As shown in FIG. 3, the substrate 10 comprises a first region 11, a bend region 12, a second region 13, and a binding region 14. The first region 11, the bend region 12, and the second region 13 are sequentially disposed side by side along a first direction. The binding region 14 is disposed adjacent to the second region 13. It should be noted that the first direction is a horizontal direction. The touch sensor layer 20 comprises a first touch sensor block 21, a second touch sensor block 22, a binding block 23, and a third touch sensor block 24. The first touch sensor block 21 is disposed on the first region 11, the second touch sensor block 22 is disposed on the second region 13, the binding block 23 is disposed on the binding region 14, and the third touch sensor block 24 is disposed on the bend region 12.

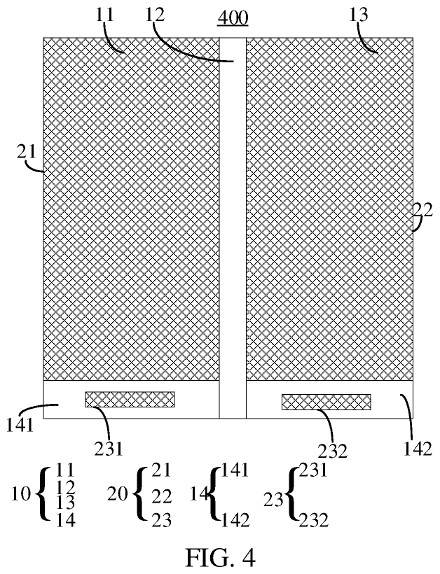

Referring to FIG. 4, it is a fourth schematic view of a touch sensor component according to one embodiment of the present invention. The difference between the touch sensor component 400 shown in FIG. 4 and the touch sensor component 100 shown in FIG. 1 is that the binding region 14 of the touch sensing component 400 shown in FIG. 4 is disposed adjacent to the first region 11 and the second region 13.

As shown in FIG. 4, the substrate 10 comprises a first region 11, a bend region 12, a second region 13, and a binding region 14. The first region 11, the bend region 12, and the second region 13 are sequentially disposed side by side along a first direction. The binding region 14 is disposed adjacent to the first region 11 and the second region 13. In other words, the binding region 14 comprises a first sub-binding region 141 and a second sub-binding region 142, the first sub-binding region 141 is disposed adjacent to the first region 11, and the second sub-binding region 142 is disposed adjacent to the second region 13. It should be noted that the first direction is a horizontal direction. The touch sensor layer 20 comprises a first touch sensor block 21, a second touch sensor block 22, and a binding block 23. The binding block 23 comprises a first sub-binding block 231 and a second sub-binding block 232. The first touch sensor block 21 is disposed on the first region 11, the second touch sensor block 22 is disposed on the second region 13, the binding block 23 is disposed on the binding region 14, and the first sub-binding block 231 is disposed on the first sub-binding region 141, and the second sub-binding block 232 is disposed on the second sub-binding region 142.

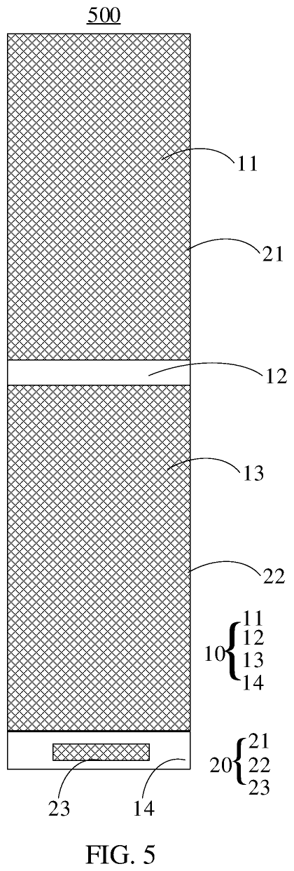

Referring to FIG. 5, it is a fifth schematic view of a touch component according to one embodiment of the present invention. The difference between the touch sensor component 500 shown in FIG. 5 and the touch sensor component 100 shown in FIG. 1 is that a first region 11, a bend region 12, a second region 13, and a binding region 14 of the touch sensor component 500 are sequentially disposed along a second direction, and the second direction is perpendicular to the first direction.

As shown in FIG. 5, the substrate 10 comprises a first region 11, a bend region 12, a second region 13, and a binding region 14. The first region 11, the bend region 12, the second region 13, and the binding region 14 are sequentially disposed side by side along a second direction. It should be noted that the second direction is a vertical direction. The touch sensor layer 20 comprises a first touch sensor block 21, a second touch sensor block 22, and a binding block 23. The first touch sensor block 21 is disposed on the first region 11, the second touch sensor block 22 is disposed on the second region 13, and the binding block 23 is disposed on the binding region 14.

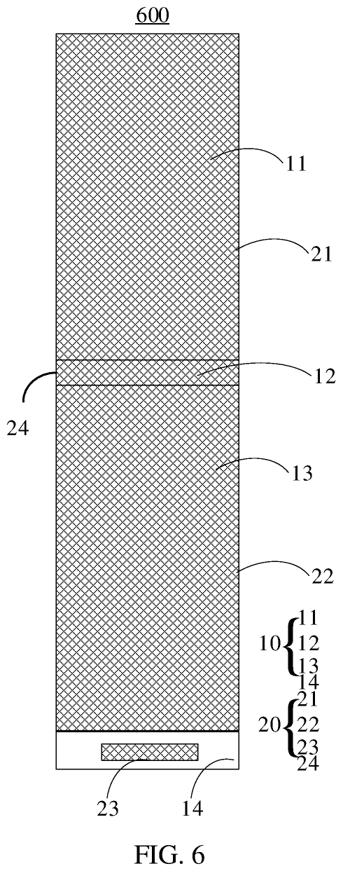

Referring to FIG. 6, it is a sixth schematic view of a touch component according to one embodiment of the present invention. The difference between the touch sensor component 600 shown in FIG. 6 and the touch sensor component 500 shown in FIG. 5 is that a touch sensor layer 20 of the touch sensor component 600 further comprises a third touch sensor block 24.

As shown in FIG. 6, the substrate 10 comprises a first region 11, a bend region 12, a second region 13, and a binding region 14. The first region 11, the bend region 12, the second region 13, and the binding region 14 are sequentially disposed side by side along a second direction. It should be noted that the second direction is a vertical direction. The touch sensor layer 20 comprises a first touch sensor block 21, a second touch sensor block 22, a binding block 23, and a third touch sensor block 24. The first touch sensor block 21 is disposed on the first region 11, the second touch sensor block 22 is disposed on the second region 13, and the binding block 23 is disposed on the binding region 14, and the third touch sensor block 24 is disposed on the bend region 12.

In further embodiment, an electronic device provided by the present invention comprises a display body and a touch sensor component. A substrate of the touch sensor component covers the display body, and a touch sensor layer of the touch sensor component is disposed on a side of the substrate away from the display body.

In one embodiment, the touch sensor component can be the touch sensor component 100 shown in FIG. 1, the touch sensor component 200 shown in FIG. 2, the touch sensor component 400 shown in FIG. 4, or the touch sensor component 500 shown in FIG. 5. The touch sensor component 100 shown in FIG. 1 is exemplified for description.

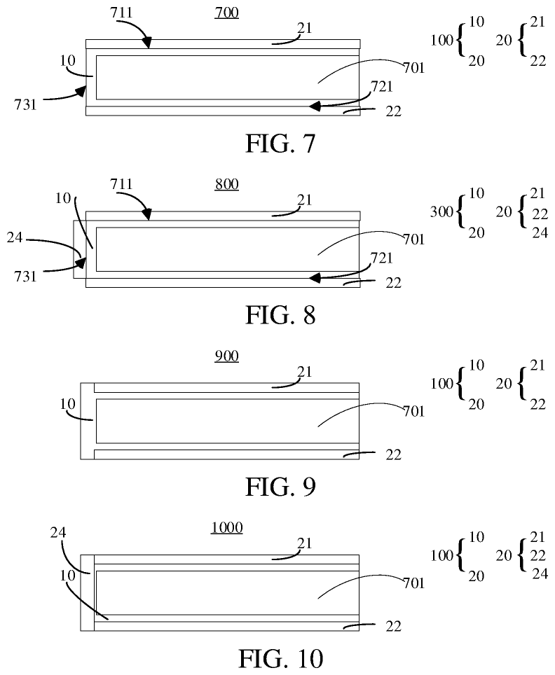

Referring to FIG. 7, it is a first schematic view of an electronic device according to one embodiment of the present invention. In combination with FIG. 1 and FIG. 7, the electronic device 700 comprises a display body 701 and a touch sensor component 100.

The display body 701 comprises a first display surface 711, a second display surface 721, and a side 731 disposed between the first display surface 711 and the second display surface 721. The touch sensor component 100 comprises a substrate 10 and a touch sensor layer 20. The substrate 10 covers the display body 701, and the touch sensor layer 20 is disposed on a side of the substrate away from the display body 701. The touch sensor layer 20 comprises a first touch sensor block 21 and a second touch sensor block 22. The first touch sensor block 21 is disposed on the first display surface 711, and the second touch sensor block 22 is disposed on the second display surface 721.

In one embodiment, a touch sensor component can be the touch sensor component 300 shown in FIG. 3 or the touch sensor component 600 shown in FIG. 6. The touch sensor component 300 shown in FIG. 3 is exemplified for description.

Referring to FIG. 8, it is a second schematic view of an electronic device according to one embodiment of the present invention. In combination with FIG. 3 and FIG. 8, the electronic device 800 comprises a display body 701 and a touch sensor component 300.

The display body 701 comprises a first display surface 711, a second display surface 721, and a side 731 disposed between the first display surface 711 and the second display surface 721. The touch sensor component 100 comprises a substrate 10 and a touch sensor layer 20. The substrate 10 covers the display body 701, and the touch sensor layer 20 is disposed on a side of the substrate away from the display body 701. The touch sensor layer 20 comprises a first touch sensor block 21, a second touch sensor block 22, and a third touch sensor block 24. The first touch sensor block 21 is disposed on the first display surface 711, the second touch sensor block 22 is disposed on the second display surface 721, and the third touch sensor 24 is disposed on the side 731 of the display body.

In further embodiment, an electronic device provided by the present invention comprises a display body and a touch sensor component. A substrate of the touch sensor component covers the display body, and a touch sensor layer of the touch sensor component is disposed on a side of the substrate close to the display body.

Referring to FIG. 9, it is a third schematic view of an electronic device according to one embodiment of the present invention. The difference between the electronic device 900 shown in FIG. 9 and the electronic device 700 shown in FIG. 7 is that the touch sensor layer 20 is disposed on a side of the substrate 10 close to the display body 701. The details can be referenced in FIG. 7 and are not described herein.

Referring to FIG. 10, it is a fourth schematic view of an electronic device according to one embodiment of the present invention. The difference between the electronic device 1000 shown in FIG. 10 and the electronic device 800 shown in FIG. 8 is that the touch sensor layer 20 is disposed on a side of the substrate 10 close to the display body 701. The details can be referenced in FIG. 7 and are not described herein. The details can be referenced in FIG. 8 and are not described herein.

A touch sensor layer of the present invention is fabricated through a foldable transparent flexible substrate, and then the touch sensor layer can be bent to cover both surfaces of the electronic device to form a double-sided touch function layer. The present invention has beneficial effects like minimizing processing steps and lowering the cost.

In the description of the specification, the descriptions of the terms “one embodiment”, “some embodiments”, “illustrative embodiments”, “example”, “specific examples”, or “some examples” and the like mean a combination the specific features, structures, materials, or characteristics described in the embodiments or examples are included in at least one embodiment or example of the application. In the present specification, the schematic representation of the above terms does not necessarily mean the same embodiment or example. Furthermore, the particular features, structures, materials, or characteristics described may be combined in a suitable manner in any one or more embodiments or examples.

In the above, the present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A touch sensor component, comprising:
a substrate, wherein the substrate comprises a first region, a bend region, a second region, and a binding region;
a touch sensor layer, wherein the touch sensor layer is disposed on the substrate, the touch sensor layer comprises a first touch sensor block, a second touch sensor block, and a binding block; the first touch sensor block is disposed on the first region, the second touch sensor block is disposed on the second region, and the binding block is disposed on the binding region;
wherein the binding block is electrically connected to the first touch sensor block and the second touch sensor block, and the binding block is configured to transmit an inductive signal of the first touch sensor block and the second touch sensor block to a touch control chip; and
wherein the first region, the bend region, and the second region are sequentially disposed side by side along a first direction, the touch senor layer further comprises a third touch sensor block, and the third touch sensor block is disposed on the bend region.

2. The touch sensor component according to claim 1, wherein the binding region is disposed adjacent to the first region and is sequentially disposed along a second direction.

3. The touch sensor component according to claim 1, wherein the binding region is disposed adjacent to the second region and is sequentially disposed along a second direction.

4. The touch sensor component according to claim 2, wherein the first direction and the second direction are perpendicular to each other.

5. The touch sensor component according to claim 3, wherein the first direction and the second direction are perpendicular to each other.

6. The touch sensor component according to claim 1, wherein the binding region is disposed adjacent to the first region and the second region.

7. The touch sensor component according to claim 6, wherein the binding region comprises a first sub-binding region and a second sub-binding region, the first sub-binding region is disposed adjacent to the first region, and the second sub-binding region is disposed adjacent to the second region; and
the binding block comprises a first sub-binding block and a second sub-binding block, the first sub-binding block is disposed on the first sub-binding region, and the second sub-binding block is disposed on the second sub-binding region.

8. A touch sensor component, comprising:
a substrate, wherein the substrate comprises a first region, a bend region, a second region, and a binding region;
a touch sensor layer, wherein the touch sensor layer is disposed on the substrate, the touch sensor layer comprises a first touch sensor block, a second touch sensor block, and a binding block; the first touch sensor block is disposed on the first region, the second touch sensor block is disposed on the second region, the binding block is disposed on the binding region, the binding block is electrically connected to the first touch sensor block and the second touch sensor block, and the binding block is configured to transmit an inductive signal of the first touch sensor block and the second touch sensor block to a touch control chip; and
wherein the first region, the bend region, and the second region are sequentially disposed side by side along a first direction, the touch senor layer further comprises a third touch sensor block, and the third touch sensor block is disposed on the bend region.

9. The touch sensor component according to claim 8, wherein the first region, the bend region, and the second region are sequentially disposed side by side along a first direction.

10. The touch sensor component according to claim 9, wherein the binding region is disposed adjacent to the first region and is sequentially disposed along a second direction.

11. The touch sensor component according to claim 9, wherein the binding region is disposed adjacent to the second region and is sequentially disposed along a second direction.

12. The touch sensor component according to claim 10, wherein the first direction and the second direction are perpendicular to each other.

13. The touch sensor component according to claim 11, wherein the first direction and the second direction are perpendicular to each other.

14. The touch sensor component according to claim 9, wherein the binding region is disposed adjacent to the first region and the second region.

15. The touch sensor component according to claim 14, wherein the binding region comprises a first sub-binding region and a second sub-binding region, the first sub-binding region is disposed adjacent to the first region, and the second sub-binding region is disposed adjacent to the second region; and
the binding block comprises a first sub-binding block and a second sub-binding block, the first sub-binding block is disposed on the first sub-binding region, and the second sub-binding block is disposed on the second sub-binding region.

16. The touch sensor component according to claim 8, wherein the touch senor layer further comprises a third touch sensor block, and the third touch sensor block is disposed on the bend region.

17. An electronic device, comprising a display body and a touch sensor component, and a substrate of the touch sensor component covers the display body;
wherein a touch sensor layer of the touch sensor component is disposed on a side of the substrate away from the display body; or the touch sensor layer of the touch sensing component is disposed on a side of the substrate close to the display body; and
wherein the touch sensor component comprises:
a substrate, wherein the substrate comprises a first region, a bend region, a second region, and a binding region;
a touch sensor layer, wherein the touch sensor layer is disposed on the substrate, the touch sensor layer comprises a first touch sensor block, a second touch sensor block, and a binding block, the first touch sensor block is disposed on the first region, the second touch sensor block is disposed on the second region, the binding block is disposed on the binding region, the binding block is electrically connected to the first touch sensor block and the second touch sensor block, and the binding block is configured to transmit an inductive signal of the first touch sensor block and the second touch sensor block to a touch control chip.

18. The electronic device according to claim 17, wherein the first region, the bend region, and the second region are sequentially disposed side by side along a first direction.

19. The electronic device according to claim 18, wherein the binding region is disposed adjacent to the first region and is sequentially disposed along a second direction.

20. The electronic device according to claim 18, wherein the binding region is disposed adjacent to the second region and is sequentially disposed along the second direction.
